(19) United States
(12) Patent Application Publication
(10) Pub. No.: US 2025/0167891 A1
(43) Pub. Date: May 22, 2025

(54) COMMUNICATION PLANNING DEVICE, SATELLITE, AND SATELLITE SYSTEM

(71) Applicant: Warpspace, INC., Ibaraki (JP)

(72) Inventors: Akihiro NAGATA, Ibaraki (JP); Satoru TSUNEMACHI, Ibaraki (JP)

(73) Assignee: Warpspace, INC., Ibaraki (JP)

(21) Appl. No.: 18/840,096

(22) PCT Filed: Feb. 22, 2023
(86) PCT No.: PCT/JP2023/006444

§ 371 Date: Aug. 21, 2024

(30) Foreign Application Priority Data
Feb. 22, 2022 (JP) 2022-025953

(51) Int. Cl. H04B 10/118; H04B 10/29

(52) U.S. Cl. CPC H04B 10/118; H04B 10/29

(57) ABSTRACT

A communication planning device according to an aspect of the present disclosure comprises: an orbit prediction unit that predicts the orbit of a relay satellite that relays communication between a satellite having an optical communication unit and an earth station; and a creation unit that creates, on the basis of the predicted orbit, control information for controlling the optical communication unit so that the optical communication unit is directed to and tracks the relay satellite in a non-planning communication period.

### TECHNICAL FIELD

The present disclosure relates to a communication planning device, a satellite, and a satellite system.

### BACKGROUND ART

Technology for communication between satellites (e.g. observation satellites, communication satellites, etc.) operated by operators such as user companies, and earth stations through relay satellites has been studied. In this technology, the use of inter-satellite optical communications, in which the satellite and the relay satellite communicate with each other through optical communications, has been studied.

In the inter-satellite optical communications studied so far, communications between a relay satellite and a satellite are carried out according to a communication plan (hereinafter referred to as communication schedule, scheduling, etc.) that is set in advance based on the positional relationship between a relay satellite orbiting in a medium altitude orbit and a satellite orbiting in a low altitude orbit. The relay satellite establishes a communication connection with a given satellite according to the predetermined schedule and transmits and receives data to and from that satellite.

In inter-satellite optical communications, known outer space optical communication technologies can be applied. For example, Japanese Patent Application Laid-Open No. 2001-203641 discloses a space optical transmission device capable of supplementary tracking and pointing in space optical communications. Also, Japanese Patent Application Laid-Open No. 2016-100855 discloses a transmitter/receiver device that superimposes and transmits data and control information in free space optical communications.

### CITATION LIST

### Patent Literature

PTL 1
Japanese Patent Application Laid-Open No. 2001-203641
PTL 2
Japanese Patent Application Laid-Open No. 2016-100855

### SUMMARY OF INVENTION

### Technical Problem

In conventional inter-satellite optical communications, relay satellites and satellites can only communicate with each other during the time periods specified in the communication schedules set in advance by the operators operating the satellites, and thus lack flexibility in terms of communication opportunities. Therefore, during periods not set in the communication schedule, even if the operator of the satellite wishes to immediately communicate with the satellite and acquire data from the satellite, it is not possible to respond to this need.

An object of the present disclosure is to provide a technique that achieves flexible communications in inter-satellite optical communications by enabling on-demand setting of a communication opportunity that is not on the predetermined communication schedule.

### Solution to Problem

A communication planning device of the present disclosure includes: an orbit prediction unit configured to predict an orbit of a relay satellite configured to relay a communication between an earth station and a satellite including an optical communication unit; and a creation unit configured to create control information for controlling the optical communication unit such that the optical communication unit directionally tracks the relay satellite based on the orbit predicted, in an unplanned communication period with a possibility of an occurrence of an unplanned communication between the satellite and the earth station, the unplanned communication being a communication not planned in advance.

### Advantageous Effects of Invention

The present disclosure provides a technique that achieves flexible communications in inter-satellite optical communications by enabling on-demand setting of a communication opportunity that is not on the predetermined communication schedule.

### BRIEF DESCRIPTION OF DRAWINGS

FIG. 1 is a schematic view illustrating a satellite and a relay satellite according to an embodiment of the present disclosure;

FIG. 2 is a schematic view illustrating a communicating range between an earth station and a satellite according to the embodiment of the present disclosure;

FIG. 3 is a schematic view illustrating communications between the earth station and the satellite through the relay satellite according to the embodiment of the present disclosure;

FIG. 4 is a block diagram illustrating hardware configurations of the satellite and the relay satellite according to the embodiment of the present disclosure;

FIG. 5 is a block diagram illustrating a hardware configuration of a communication planning device according to the embodiment of the present disclosure;

FIG. 6 is a block diagram illustrating a functional block configuration of the satellite according to the embodiment of the present disclosure;

FIG. 7 is a block diagram illustrating a functional block configuration of the relay satellite according to the embodiment of the present disclosure;

FIG. 8 is a block diagram illustrating a functional block configuration of the communication planning device according to the embodiment of the present disclosure;

FIG. 9 is a schematic view illustrating a start procedure of an unplanned communication according to an example of the present disclosure;

FIG. 10 is a sequence diagram illustrating an exemplary operation of the satellite system before an unplanned communication preparation completed state according to the embodiment of the present disclosure is set; and

FIG. 11 is a sequence diagram illustrating an exemplary operation of the satellite system at the start of the unplanned communication according to the embodiment of the present disclosure.

### DESCRIPTION OF EMBODIMENTS

A satellite system according to an embodiment of the present disclosure is described below with reference to the accompanying drawings.

### Satellite System

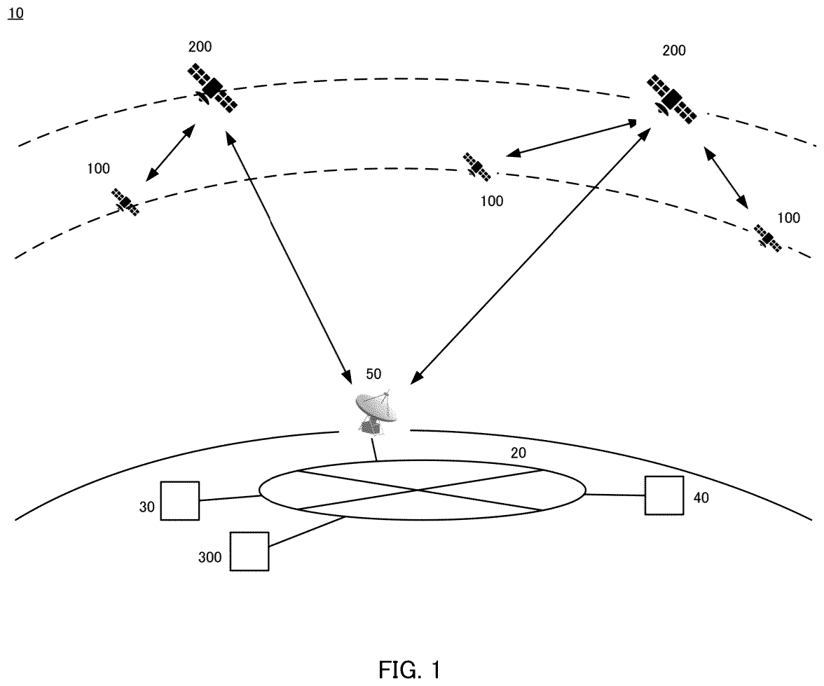

As illustrated in FIG. 1, satellite system 10 includes earth station 50, satellite 100, relay satellite 200, and communication planning device 300. FIG. 1 illustrates three satellites 100 and two relay satellites 200, but the present disclosure is not limited to this. One satellite 100 may be provided, or two or four or more satellites 100 may be provided. One relay satellite 200 may be provided, or three or more relay satellites may be provided. In addition, to ensure communications with relay satellite 200 orbiting the earth at all times, a plurality of earth stations 50 may be provided in a plurality of countries or regions of the earth.

In the present embodiment, satellite 100 and relay satellite 200 orbit the earth in different orbits. For example, in the case where satellite 100 is an observation satellite, it is possible to make up a satellite constellation with a plurality of satellites 100 to orbit in a given configuration such that earth-wide observation can be achieved with the plurality of satellites 100.

Satellite 100 is an artificial satellite, such as an observation satellite and a communication satellite, that orbits at a given altitude and has a predetermined function, but this is not limitative.

Relay satellite 200 functions as a relay station for data transmission and reception between earth station 50 and satellite 100, but this is not limitative. In the present embodiment, relay satellite 200 orbits in an orbit at a higher altitude than that of satellite 100. Typically, relay satellite 200 can cover a plurality of satellites 100.

For example, satellite 100 orbits in a low earth orbit (LEO). The low earth orbit is at an altitude of approximately 20 km to 2,000 km from the earth's surface, for example. In addition, relay satellite 200 orbits in a medium earth orbit (MEO), for example. The medium earth orbit is at an altitude of approximately 1,000 km to 36,0000 km from the earth's surface, for example. In this manner, the positions of satellite 100 and relay satellite 200 as viewed from earth station 50 change depending on the time. In addition, the relative positions of satellite 100 and relay satellite 200 change depending on the time.

Earth station 50 is a communication station that directly communicates with satellite 100, or indirectly communicates with satellite 100 through relay satellite 200. In addition, in the case where a plurality of earth stations 50 is provided, relay satellite operator 30 may use a given earth station 50_1 (not illustrated) for only communications with relay satellite 200 without using it for the communications with satellite 100 through relay satellite 200. While earth station 50 is installed on the ground in the example illustrated in FIG. 1, the earth station of the present disclosure is not limited to this. The earth station of the present disclosure may be a communication station of a non-terrestrial network (NTN) constructed in the stratosphere or the like, for example. Earth station 50 can be communicatively connected with relay satellite operator 30, satellite operator 40, and communication planning device 300 through network 20 such as the Internet, for example. The information acquired by earth station 50 from satellite 100 is passed on to relay satellite operator 30, satellite operator 40, and/or communication planning device 300 through the Internet.

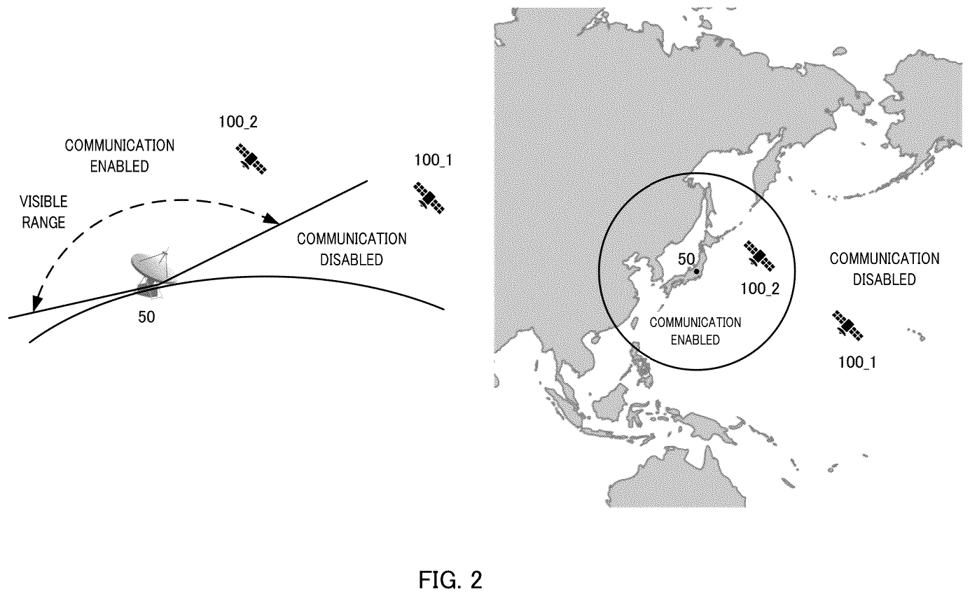

As illustrated in FIG. 2, the communicating range of earth station 50 with satellite 100 is defined by the visible range of earth station 50. In the example illustrated in FIG. 2, earth station 50 can communicate with satellite 100_2 that is within the communicating range, but cannot communicate with satellite 100_1 that is within the non-communicating range.

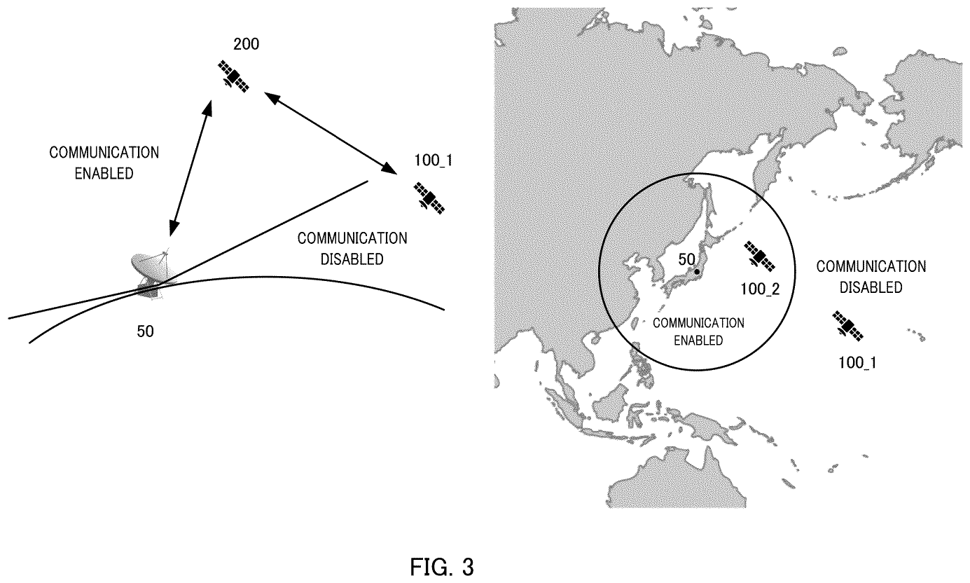

On the other hand, as illustrated in FIG. 3, by using relay satellite 200 that is within the communicating range, earth station 50 can communicate with satellite 100_1 that is within the non-communicating range through relay satellite 200.

Communication planning device 300 is a device that performs a communication plan related to inter-satellite optical communications between satellite 100 and relay satellite 200. Communication planning device 300 is a computer such as a PC (Personal Computer), for example. Communication planning device 300 is managed and/or run by relay satellite operator 30, for example. Details of communication planning device 300 are described later.

### Overview of Present Disclosure

Communications between earth station 50 and satellite 100 through relay satellite 200 are normally performed based on a communication schedule set in advance. The communication schedule is a schedule that is set in advance by relay satellite operator 30 and/or satellite operator 40, and represents the time or time period of the communications between earth station 50 and satellite 100 through relay satellite 200. The communication schedule is set in advance for a predetermined period from a predetermined time after the current time, and is shared in the entire satellite system 10, for example.

The predetermined period is set to 24 hours, 48 hours and the like, for example. The communication schedule is set based on the predicted orbits of satellite 100 and relay satellite 200 in the predetermined period. In the present embodiment, the communication schedule of a satellite 100 is set to include the time (time period or time) for the communication, and information representing which relay satellite 200 of a plurality of relay satellites 200 is relayed for the communication.

As used herein, a communication in accordance with a communication schedule, i.e., a preliminarily planned communication is referred to as planned communication. Further, a period for which a planned communication in accordance with a communication schedule is performed is referred to as planned communication period.

On the other hand, in a period other than the planned communication period, satellite operator 40 or relay satellite operator 30 may desire immediate communication between earth station 50 and satellite 100. As a specific example, if satellite 100 is an observation satellite and an event such as an earthquake, tsunami, eruption, fire or other natural disaster or a terrorist attack occurs in a certain region in the earth, satellite operator 40 may desire to immediately obtain observation data on the location of the event by satellite 100. In such case, satellite operator 40 needs to request relay satellite operator 30 for communication opportunity that is not on the predetermined communication schedule, and needs to set on-demand the communication between satellite 100 and earth station 50 through relay satellite 200.

The present embodiment describes a technique of setting on-demand the opportunity of the inter-satellite optical communication that is not on the predetermined communication schedule in a period other than the planned communication period set in advance in the above-described manner. In the following description, a communication that is performed in a period other than the planned communication period and is not on the predetermined communication schedule between satellite 100 and relay satellite 200 is referred to as unplanned communication. In addition, a period in which satellite 100 may receive from relay satellite 200 a signal requesting an unplanned communication that is not planned in advance is referred to as unplanned communication period.

### Hardware Configurations of Satellite and Relay Satellite

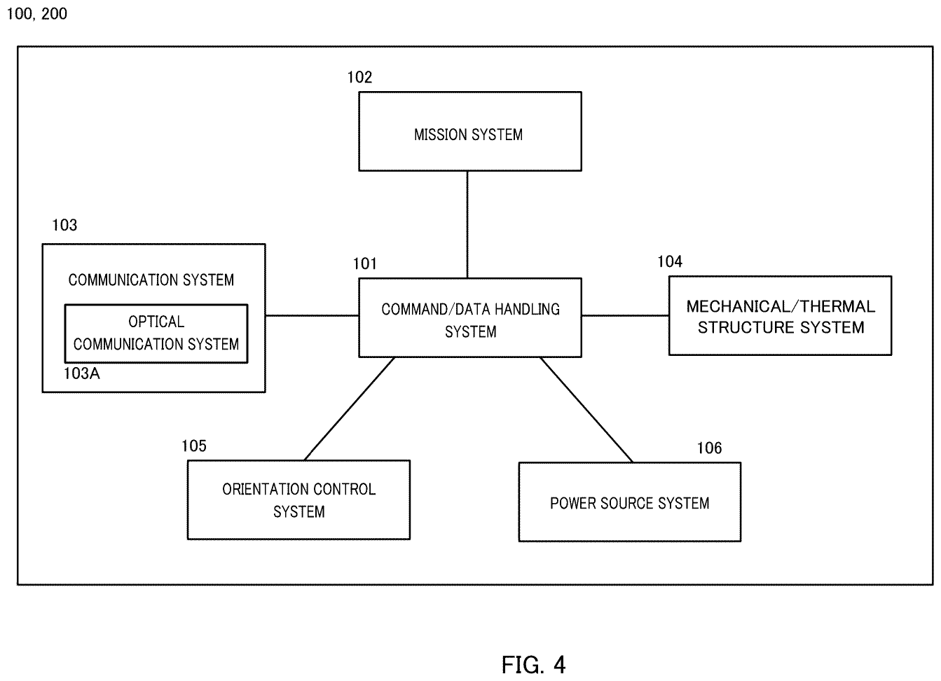

Satellite 100 and relay satellite 200 have hardware configurations illustrated as examples in FIG. 4, for example. Satellite 100 and relay satellite 200 have hardware that is classified as command/data handling system 101, mission system 102, communication system 103, mechanical/thermal structure system 104, orientation control system 105, and power source system 106.

Command/data handling system 101 processes received commands, as well as status data of the satellite, mission data and the like. For example, command/data handling system 101 includes a data processing circuit, and achieves various functional parts described later by using the processing circuit.

Mission system 102 achieves functions (missions) specific to respective satellites. For example, in the case where the satellite is an earth observation satellite, mission system 102 may be composed of a sensor and a data processing device, and the like. In addition, in the case where the satellite communication is a satellite, mission system 102 may be composed of a data relaying antenna, a communication device, and the like.

Communication system 103 may be composed of a communication device, an antenna, and the like that receive a command from earth station 50, and transmit to earth station 50 the status of the satellite, the observation data of the satellite, the telemetry and the like. In addition, communication system 103 of satellite 100 includes a camera for capturing the surroundings of the satellite to capture the image of non-terrestrial regions such as the outer space, and includes optical communication system 103A that receives and emits communication light and beacon light for inter-satellite optical communications. For example, the camera captures at all times the non-terrestrial regions around the satellite at a predetermined frame rate (e.g., 30 fps), and passes on the image frame of the captured non-terrestrial regions to command/data handling system 101 and the like.

Mechanical/thermal structure system 104 is composed of a satellite body, a movable deployment such as a photovoltaic panel, and a mechanism that exhausts heat and stabilizes the inner temperature of the satellite.

Orientation control system 105 is composed of a sensor that measures the position and/or orientation of the satellite, a propulsor that changes the altitude and/or orientation of the satellite, and the like, and controls the orientation and/or position of the satellite on the orbit.

Power source system 106 controls and manages the power used in the satellite. For example, power source system 106 charges a battery with the power generated by a solar battery, and supplies the power required for each system in the satellite.

Note that the above-described hardware configuration is merely an example, and satellite 100 and relay satellite 200 according to the present disclosure may be achieved with other appropriate hardware configurations. In addition, the above-described grouping of each system is merely an example, and the hardware configurations of satellite 100 and relay satellite 200 may be described by other groupings. For example, the same device and mechanism may be classified as different systems in accordance with the mission of the satellite. For example, a main mission of relay satellite 200 is data relay through optical communications, and therefore the optical communicator (e.g., a camera, an optical transmission device and the like) and the data relaying device may be classified as mission system 102. On the other hand, a mission of satellite 100 is earth observation and the like, and therefore various observation sensors, the data processing device and the like may be classified as mission system 102, and the optical communicator with relay satellite 200 (e.g., a camera, an optical transmission device and the like) may be classified as communication system 103.

### Hardware Configuration of Communication Planning Device 300

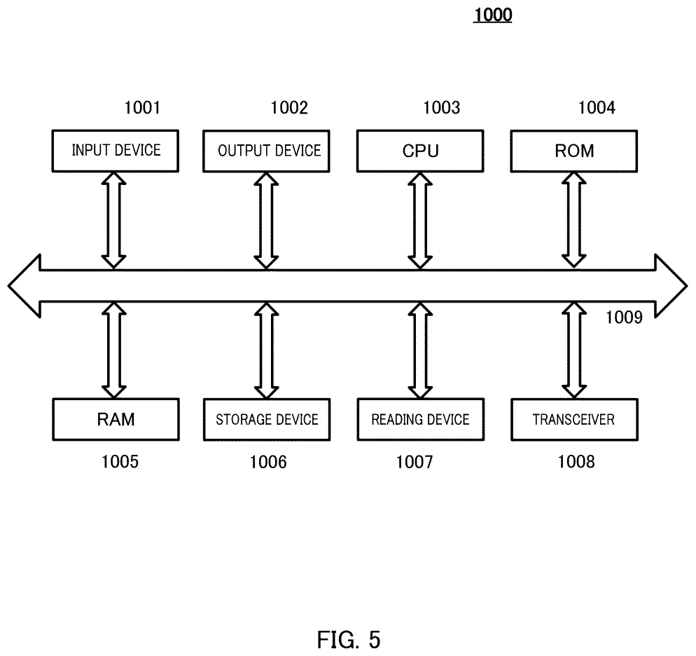

Next, with reference to FIG. 5, a hardware configuration of computer 1000 making up communication planning device 300 is described. FIG. 2 is a diagram illustrating an exemplary hardware configuration of computer 1000.

Computer 1000 includes input device 1001 such as a keyboard, a mouse and a touch pad, output device 1002 such as a display and a speaker, CPU (Central Processing Unit) 1003, ROM (Read Only Memory) 1004, RAM (Random Access Memory) 1005, storage device 1006 such as a hard disk device and an SSD (Solid State Drive), reading device 1007 for reading information from a recording medium such as a DVD-ROM (Digital Versatile Disk Read Only Memory) and a USB (Universal Serial Bus) memory, and transceiver 1008 for performing communication through a network, which are connected through bus 1009.

Further, from a recording medium storing programs for achieving functions of communication planning device 300, reading device 1007 reads the programs, and stores them in storage device 1006. Alternatively, transceiver 1008 communicates with a system device connected to the network, and stores in storage device 1006 the programs for achieving functions of communication planning device 300 downloaded from the system device.

CPU 1003 copies the programs stored in storage device 1006 to RAM 1005, and sequentially reads and executes the commands included in the programs RAM 1005, thus achieving the functions of communication planning device 300.

### Configuration of Satellite Software

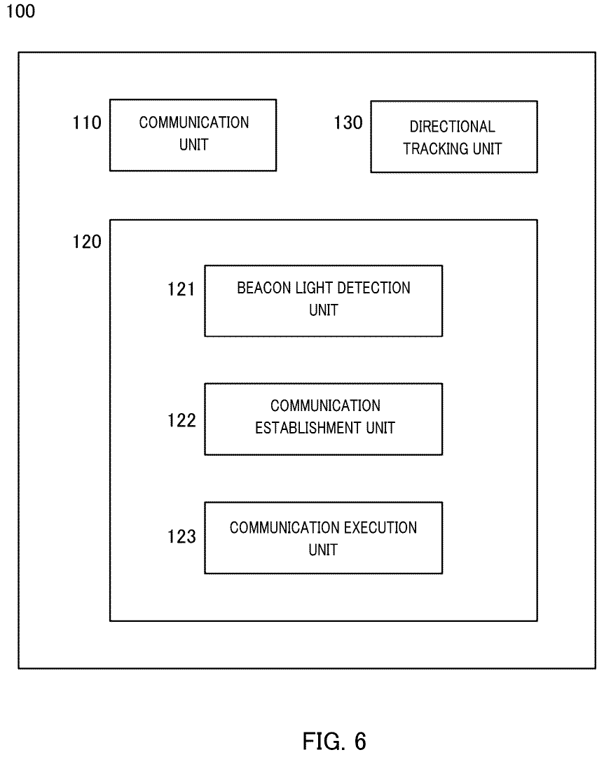

Next, with reference to FIG. 6, a functional block configuration of satellite 100 according to an embodiment of the present disclosure is described.

As illustrated in FIG. 6, satellite 100 includes communication unit 110, optical communication unit 120, and directional tracking unit 130. Processing of each functional block may be achieved by any of systems including the above-described hardware configurations, software for controlling the systems included in the hardware configurations, or combinations of them.

Communication unit 110 performs communications with earth station 50. In this manner, data can be transmitted and received to and from satellite 100 and earth station 50 while satellite 100 is located in the communicating range of earth station 50. Communication unit 110 receives from earth station 50 communication schedule information for the planned communication with relay satellite 200 in the planned communication period, and control information for directionally tracking relay satellite 200 in the unplanned communication period. The control information is elaborated later.

Optical communication unit 120 performs inter-satellite optical communications with relay satellite 200. Optical communication unit 120 includes beacon light detection unit 121, communication establishment unit 122, and communication execution unit 123.

In the planned communication period, beacon light detection unit 121 detects the beacon light transmitted by relay satellite 200 based on the communication schedule at the start of inter-satellite optical communications with relay satellite 200. Further, in the unplanned communication period, beacon light detection unit 121 detects the beacon light transmitted by relay satellite 200 in accordance with the communication request received from earth station 50. Beacon light detection unit 121 acquires an optical signal from an image of a region including imaging relay satellite 200 captured by a camera provided in satellite 100, extracts bright spots serving as beacon light candidates through image processing, and detects beacon light on the basis of the determination process of the extracted bright spots. Alternatively, beacon light detection unit 121 may detect beacon light directly received from specific relay satellite 200 that is being directionally tracked by directional tracking unit 130 described later. In this case, satellite 100 does not need to include a camera, which can reduce the manufacture cost of satellite 100.

Communication establishment unit 122 starts a communication establishment procedure with relay satellite 200 when beacon light detection unit 121 detects beacon light including a communication request for the own satellite. For example, communication establishment unit 122 transmits to relay satellite 200 a response signal representing a response to the communication request included in the beacon light, and establishes a communicative connection in accordance with the communication establishment procedure defined in advance between relay satellite 200 and satellite 100. The response signal includes the identifier of satellite 100, the identifier of relay satellite 200 and the like, for example.

When communicative connection with relay satellite 200 is established, communication execution unit 123 executes inter-satellite optical communications with relay satellite 200 by using communication light. Note that in the case where the communication cannot be established for some reasons, optical communication unit 120 executes a retry a predefined number of times. In the case where the communication cannot be established even by the retry, satellite 100 may provide a notification of information representing the failure of communication establishment to relay satellite operator 30 and/or satellite operator 40 through earth station 50.

On the basis of the control information including the location information of specific relay satellite 200 to be directionally tracked in the unplanned communication period, directional tracking unit 130 controls optical communication unit 120 such that optical communication system 103A (see FIG. 4) directionally tracks specific relay satellite 200 in the unplanned communication period. In this manner, optical communication unit 120 can easily detect the beacon light from specific relay satellite 200 in the unplanned communication period, and thus the unplanned communication can be established in a short time.

### Software Configuration of Relay Satellite 200

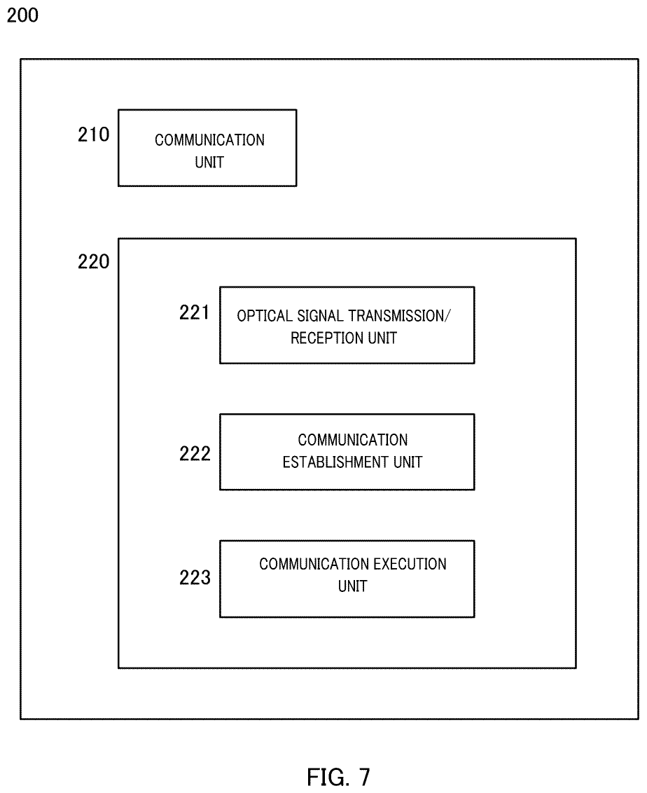

Next, with reference to FIG. 7, a software configuration of relay satellite 200 according to an embodiment of the present disclosure is described.

### Relay Satellite

As illustrated in FIG. 7, relay satellite 200 includes communication unit 210, and optical communication unit 220. The function of each software is achieved by any of the systems included in the above-described hardware configuration or combinations of them.

Communication unit 210 performs communications with earth station 50. In this manner, data can be transmitted and received to and from relay satellite 200 and earth station 50. Communication unit 210 receives from earth station 50 communication schedule information for the planned communication with relay satellite 200 in the planned communication period, and communication request information including a start request of the unplanned communication with satellite 100 in the unplanned communication period.

Optical communication unit 220 performs inter-satellite optical communications with satellite 100. Optical communication unit 220 includes optical signal transmission/reception unit 221, communication establishment unit 222, and communication execution unit 223.

Optical signal transmission/reception unit 221 transmits to satellite 100 beacon light in accordance with the communication request information or the communication schedule information received from earth station 50, and receives a response signal from satellite 100 that has detected the beacon light. For example, the beacon light may be an optical signal with a lower directivity (larger angle of divergence) than that of the communication light that is transmitted after the establishment of optical communicative connection with satellite 100. In this case, the beacon light is transmitted to a relatively wider region than the communication light, and thus satellite 100 can easily receive the beacon light. Alternatively, optical signal transmission/reception unit 221 may perform scanning toward the possible range of satellite 100 with an optical signal with approximately the same directivity as that of the communication light, or a higher directivity (smaller angle of divergence) than that of the communication light.

Optical signal transmission/reception unit 221 may transmit beacon light with a predetermined flick pattern representing encoded information. With this flick pattern, satellite 100 that has received the beacon light can determine whether the beacon light is destined for the own satellite.

When receiving the response signal from satellite 100, optical signal transmission/reception unit 221 determines whether the received response signal is destined for the own satellite on the basis of the identifier of satellite 100 and the identifier of relay satellite 200 included in the response signal.

When optical signal transmission/reception unit 221 receives a response signal destined for the own satellite, communication establishment unit 222 starts the communication establishment procedure with satellite 100. For example, communication establishment unit 222 establishes a communicative connection in accordance with the communication establishment procedure defined in advance between relay satellite 200 and satellite 100.

When the communicative connection with satellite 100 is established, communication execution unit 223 executes inter-satellite optical communications with satellite 100 by using the communication light. Note that in the case where the communication cannot be established for some reasons, optical communication unit 220 executes a retry a predefined number of times. In the case where the communication cannot be established even by the retry, relay satellite 200 may provide a notification of information representing the failure of communication establishment to relay satellite operator 30 and/or satellite operator 40 through earth station 50.

### Functional Block Configuration of Communication Planning Device 300

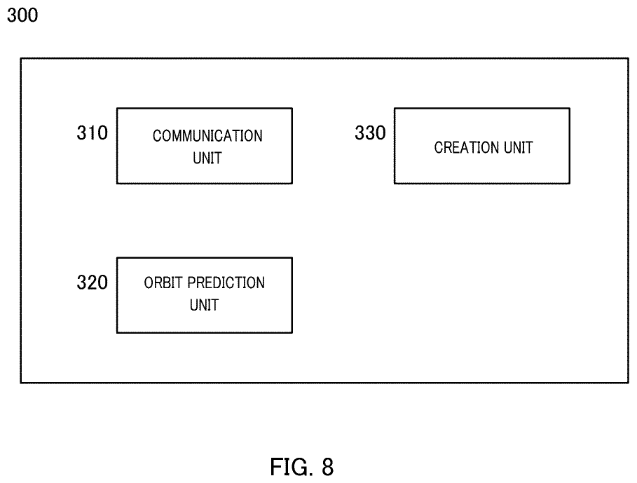

Next, with reference to FIG. 8, a functional block configuration of communication planning device 300 according to the embodiment of the present disclosure is described.

As illustrated in FIG. 8, communication planning device 300 includes communication unit 310, orbit prediction unit 320, and creation unit 330.

Communication unit 310 performs communications with satellite 100 and/or relay satellite 200 through network 20 and earth station 50. In this manner, communication unit 310 can transmit a variety of information to satellite 100 and/or relay satellite 200.

Orbit prediction unit 320 predicts the orbit of satellite 100 and/or relay satellite 200 in the planned communication period. Further, orbit prediction unit 320 predicts the orbits of satellite 100 and relay satellite 200 in the unplanned communication period. The technique of predicting the orbits of satellite 100 and relay satellite 200 by orbit prediction unit 320 may be a known technique. An example of the orbit prediction technique is a technique using Kalman filters. Note that orbit prediction unit 320 may receive the orbit prediction information of satellite 100 from satellite operator 40 of satellite 100.

To achieve unplanned communication between satellite 100 and relay satellite 200, creation unit 330 creates the control information to be transmitted to satellite 100 and the communication request information to be transmitted to relay satellite 200. Note that the control information may be created by satellite operator 40 of satellite 100 on the basis of the orbit of relay satellite 200 in the unplanned communication period predicted by orbit prediction unit 320. In addition, the control information created by creation unit 330 may be transmitted to satellite operator 40 who operates satellite 100, and satellite operator 40 may further create entire control information, including the control information, for performing the operation control of the entire satellite 100.

First, as a preparation for unplanned communication, creation unit 330 sets as the unplanned communication period a specific period from a specific time after the current time in the reference time of satellite system 10, and creates the control information that controls optical communication unit 120 of satellite 100 such that optical communication system 103A directionally tracks a specific relay satellite 200 in the unplanned communication period. The control information created by creation unit 330 is information for causing satellite 100 to control optical communication unit 120, not information for operation control of the entire satellite. The entire control information for the operation control of the entire satellite 100 may be created by satellite operator 40 as described above.

An example of the unplanned communication period is given 24 hours or 48 hours in the reference time of satellite system 10, for example. More specifically, in the case where the current time of satellite system 10 is March 1, 9 am, creation unit 330 may set 48 hours from March 1, 12 am to March 3, 12 am as the unplanned communication period. These times are only examples and may be changed as appropriate. For example, in the case where satellite 100 is an earth observation satellite and satellite operator 40 desires to acquire data on demand from satellite 100 in a specific future period, a request for relay satellite operator 30 is provided to set the unplanned communication period for the specific period. In addition, the unplanned communication period may be set to each of the plurality of satellites 100. The unplanned communication period is not set only once, and new unplanned communication period may be set at any time over time. For example, after 48 hours from March 1, 12 am to March 3, 12 am is set as the unplanned communication period, 48 hours from March 3, 12 am to March 5, 12 am may be set over time as new unplanned communication period.

Note that in the present embodiment, the unplanned communication period is set to 24 hours or 48 hours in consideration of the balance between the amount of the computation for creation unit 330 to estimate the orbits of satellite 100 and/or relay satellite 200 in the planned communication period, and the frequency of the uplink of the control information to satellite 100. In the case where the computation resource of creation unit 330 is sufficiently large, the unplanned communication period may be set to a longer period. On the other hand, in the case where the frequency of transmission of the communication request information and the control information created by creation unit 330 to satellite 100 or relay satellite 200 through earth station 50 is allowed to be high, the unplanned communication period may be set to a shorter period. The orbit prediction and location information of satellite 100 and relay satellite 200 are computed and specified on the basis of the barycentric celestial reference system and the like, for example.

Creation unit 330 creates the control information including the location information of specific relay satellite 200 to be directionally tracked by satellite 100 in the unplanned communication period on the basis of the predicted orbits of satellite 100 and relay satellite 200. More specifically, on the basis of the relative position of satellite 100 and relay satellite 200 that is estimated on the basis of the predicted orbit at each time point in the unplanned communication period, creation unit 330 specifies the direction of optical communication system 103A of satellite 100, and creates the control information to direct optical communication system 103A to the specified direction.

It suffices that the control information includes the following information, for example. Specifically, examples of such information include the identification information (e.g., predetermined ID) of satellite 100 to be subjected to the unplanned communication, the start time (absolute time) of the unplanned communication, and the prediction position coordinate information and its error range of satellite 100 at a predetermined interval (e.g., an interval of 1 second). Note that in the prediction position coordinate information, the coordinate system may be a barycentric celestial reference system, an earth centered inertial system, or a galileo terrestrial reference system.

Note that in the present embodiment, there is a plurality of relay satellites 200, and therefore when performing unplanned communication with one satellite 100, it is necessary to select relay satellite 200 for relaying the satellite 100 from among the plurality of relay satellites 200. In this specification, relay satellite 200 for relaying satellite 100 may be referred to as first relay satellite 200_1.

When creating the communication request information, creation unit 330 estimates the positional relationship of earth station 50, satellite 100, and relay satellite 200 at each time point in the unplanned communication period on the basis of the predicted orbit, and determines relay satellite 200 for the relay on the basis of the positional relationship. Creation unit 330 or satellite operator 40 derives the direction where first relay satellite 200_1 determined as viewed from satellite 100 is present at each time point in the unplanned communication period, and creates the control information to be transmitted to satellite 100. Note that since the positional relationship of earth station 50, satellite 100, and relay satellite 200 always changes, relay satellite 200 for the relay may be required to be changed over time among the plurality of relay satellites 200. In this case, the control information is information of controlling optical communication system 103A to the directions of different relay satellites before and after a certain time point.

The control information created by creation unit 330 or satellite operator 40 is uplinked to satellite 100 through earth station 50. Satellite 100 that has received the control information directs optical communication system 103A to the direction indicated by the control information over the unplanned communication period. The direction indicated by the control information is the direction where first relay satellite 200_1 is present as viewed from satellite 100 at that time point. In this manner, when beacon light requesting the start of the unplanned communication is sent from relay satellite 200 in the unplanned communication period, satellite 100 can reliably detect the beacon light. Since the control information indicates the direction at each time point in the unplanned communication period, satellite 100 can cause optical communication system 103A to continuously perform the directional tracking toward the direction where relay satellite 200 is present in the unplanned communication period.

Note that desirably the start time of the unplanned communication period is determined in consideration of the time from the current time of satellite system 10 until creation unit 330 creates the control information, the control information is received by satellite 100, and optical communication system 103A is directed to the direction where relay satellite 200 is present.

In this manner, when the control information created by creation unit 330 is received by satellite 100, the preparation for the unplanned communication between satellite 100 and first relay satellite 200_1 in the unplanned communication period is completed. In the following description, the state where the control information is transmitted to satellite 100 and optical communication system 103A of satellite 100 is directionally tracking the direction where first relay satellite 200_1 is present is referred to as unplanned communication preparation completed state.

The unplanned communication preparation completed state is a state where the unplanned communication between satellite 100 and first relay satellite 200_1 is not yet performed. When an unplanned communication start request is sent from satellite operator 40 to communication planning device 300 within the unplanned communication period, creation unit 330 creates communication request information for actually starting the unplanned communication.

The communication request information includes the start time of the unplanned communication, and the direction where satellite 100 is present as viewed from first relay satellite 200_1 at the start time. The start time of the unplanned communication is determined by satellite operator 40, for example.

Creation unit 330 derives the direction where satellite 100 is present as viewed from first relay satellite 200_1 from the positional relationship of earth station 50, satellite 100, and relay satellite 200 at each time point in the unplanned communication period that is estimated based on the predicted orbit. In this manner, creation unit 330 creates the communication request information.

The communication request information created by creation unit 330 is uplinked to first relay satellite 200_1 through earth station 50. When the unplanned communication start time arrives, first relay satellite 200_1 that has received the communication request information transmits beacon light for starting the optical communications toward the direction included in the communication request information.

In the unplanned communication period, satellite 100 is causing optical communication system 103A to perform directional tracking in the direction of first relay satellite 200_1, and therefore the beacon light sent from first relay satellite 200_1 is received by optical communication unit 120. In this manner, the unplanned communication between earth station 50 and satellite 100 can be started through first relay satellite 200_1.

### Start Procedure of Unplanned Communication

Next, a start procedure of unplanned communication is described.

When satellite operator 40 desires to perform unplanned communications with a specific satellite 100, satellite operator 40 transmits a start request of the unplanned communication to communication planning device 300. Communication planning device 300 transmits through earth station 50 the communication request information for relay satellite 200 located at a position where it can perform optical communications with the satellite 100. When receiving the communication request information from earth station 50, relay satellite 200 transmits beacon light onto the orbit where satellite 100 is orbiting. The beacon light may be an optical signal in a pulse form encoded with the identifier of relay satellite 200 and the identifier of satellite 100 of the communication partner, for example.

When receiving the beacon light, satellite 100 analyzes the content, and when determining that relay satellite 200 has requested that satellite 100 is the communication partner, satellite 100 sends back a response signal for establishing a communicative connection with relay satellite 200 of the transmission source of the beacon light. In this manner, the optical communication between satellite 100 and relay satellite 200 is established, and the unplanned communication between earth station 50 and satellite 100 is started through relay satellite 200.

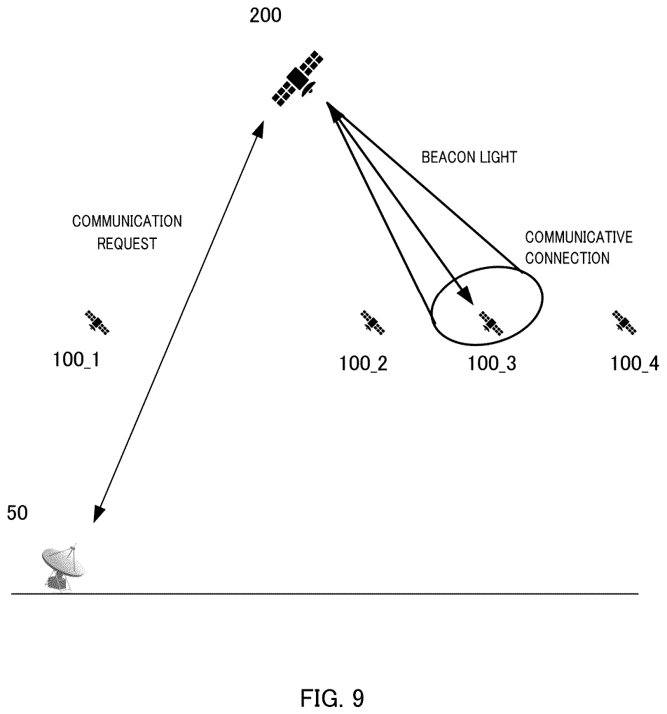

FIG. 9 illustrates an overview of a start procedure of unplanned communications in the case where unplanned communications between earth station 50 and satellite 100_3 from among the plurality of satellites 100_1, 100_2, 100_3, 100_4 are desired.

Earth station 50 transmits to relay satellite 200 communication request information requesting communications with satellite 100_3. The communication request information includes information representing the direction of satellite 100_3 as viewed from relay satellite 200, and relay satellite 200 transmits beacon light toward that direction.

Satellite 100_3 receives the beacon light transmitted from relay satellite 200. At this time, with the control information, satellite 100_3 is controlling optical communication unit 120 such that optical communication system 103A performs directional tracking in the direction where relay satellite 200 is present. In this manner, satellite 100_3 can easily receive and detect the beacon light transmitted by relay satellite 200.

When receiving the beacon light from relay satellite 200, satellite 100_3 extracts the identifier of the requested communication partner and the identifier of relay satellite 200 encoded in the beacon light. Satellite 100_3 determines whether the identifier of the extracted communication partner matches the own identifier. In this example, the identifier of satellite 100_3 is included in the beacon light, and therefore satellite 100_3 determines that satellite 100_3 is requested as the communication partner, and shifts to the communication establishment procedure with relay satellite 200. When the communicative connection between satellite 100_3 and relay satellite 200 is established in accordance with the predetermined communication establishment procedure, satellite 100_3 and relay satellite 200 exchange data through the optical communications. In addition, the beacon light may be a given blink pattern that does not include the identifier of relay satellite 200, and in that case, satellite 100 that has detected the beacon light may determine from the blink pattern that the beacon light has been output from a predetermined relay satellite.

Through such a procedure, the unplanned communication between earth station 50 and satellite 100 through relay satellite 200 can be started at the desired timing.

### Exemplary Operations

The processes of the functional blocks included in satellite system 10 are described above. Now exemplary operations of satellite system 10 before the start of the unplanned communication period and during the unplanned communication period are described below.

### Exemplary Operation of Satellite System 10 Before Unplanned Communication Preparation Completed State

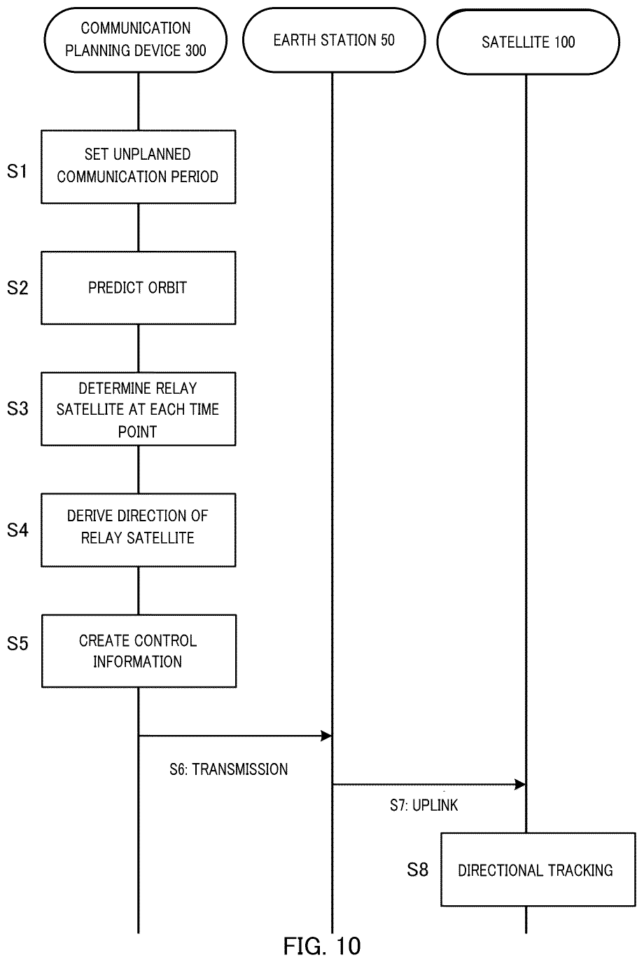

With reference to FIG. 10, exemplary operations of the configurations of satellite system 10 before the unplanned communication preparation completed state is set are described below.

At step S1, communication planning device 300 sets the unplanned communication period.

At step S2, communication planning device 300 predicts the orbits of satellite 100 and relay satellite 200 in the unplanned communication period.

At step S3, communication planning device 300 determine relay satellite 200 for the relay at each time point in the unplanned communication period.

At step S4, communication planning device 300 derives the direction of relay satellite 200 as viewed from satellite 100.

At step S5, communication planning device 300 creates information for directing optical communication system 103A of satellite 100 to the direction of relay satellite 200 at each time point in the unplanned communication period.

At step S6, communication planning device 300 transmits the control information to earth station 50.

At step S7, earth station 50 transmits (uplinks) the control information to satellite 100. At step S7, earth station 50 may transmit (uplink) the control information to satellite 100 through relay satellite 200 by using the planned communication planned in advance, or may directly uplink the control information to satellite 100 not through relay satellite 200 by waiting for satellite 100 coming into the communicating range of earth station 50.

At step S8, satellite 100 causes optical communication system 103A to directionally track relay satellite 200 in accordance with the control information. In this manner, satellite system 10 is set to the unplanned communication preparation completed state.

### Exemplary Operation of Satellite System 10 at Start of Unplanned Communication

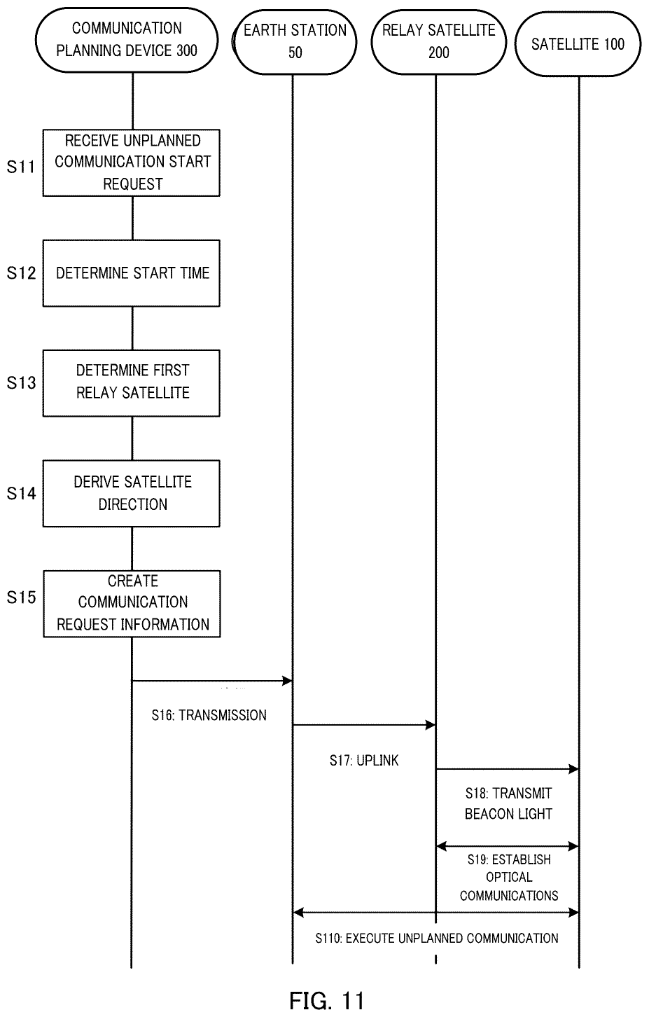

With reference to FIG. 11, exemplary operations of satellite system 10 at the start of the unplanned communication are described below.

At step S11, in the unplanned communication period, communication planning device 300 receives a start request of the unplanned communication from satellite operator 40 and the like.

At step S12, communication planning device 300 determines the start time of the requested unplanned communication. In the case where satellite operator 40 designates the start time, communication planning device 300 may set that time as the start time, or communication planning device 300 may determine the start time in consideration of the time taken for creating the communication request information of the unplanned communication, the time taken for the uplink to relay satellite 200, the time taken for the communication preparation at relay satellite 200, and the like, for example.

At step S13, communication planning device 300 determines first relay satellite 200_1 for relaying the requested unplanned communication based on the predicted orbit.

At step S14, communication planning device 300 derives the direction of satellite 100 as viewed from first relay satellite 200_1 at the start time of the unplanned communication based on the predicted orbit.

At step S15, communication planning device 300 creates the communication request information including the location information of satellite 100 for first relay satellite 200_1.

At step S16, communication planning device 300 transmits the communication request information to earth station 50.

At step S17, earth station 50 uplinks the communication request information to first relay satellite 200_1.

At step S18, first relay satellite 200_1 transmits beacon light for starting the optical communications to satellite 100 based on the communication request information.

At step S19, the inter-satellite optical communication is established between first relay satellite 200_1 and satellite 100.

At step S110, the unplanned communication between earth station 50 and satellite 100 through first relay satellite 200_1 is performed.

Note that in the example illustrated in FIG. 11, at step S16 and step S17, the communication request information created by communication planning device 300 is transmitted to first relay satellite 200_1 through earth station 50. However, the communication request information created by communication planning device 300 may be transmitted to relay satellite 200 through another earth station 50_1 that performs communications with relay satellite 200 without performing communications with satellite 100.

### Operations and Effects

As described above, with satellite system 10 according to the present disclosure, communication planning device 300 determines in advance relay satellite 200 for relaying communications between earth station 50 and satellite 100 in the unplanned communication period with a possibility of an occurrence of the unplanned communication not planned in advance, and the control information of controlling optical communication unit 120 of satellite 100 such that optical communication system 103A of satellite 100 directionally tracks the determined relay satellite 200 is created. With the control information, satellite 100 can be continuously directed to the direction where relay satellite 200 for the relay is present in the unplanned communication period.

In this manner, when the unplanned communication is actually started and the beacon light for establishing the inter-satellite optical communications is sent from relay satellite 200 toward satellite 100, satellite 100 can immediately receive the transmitted beacon light and establish the optical communications with relay satellite 200.

With this configuration, satellite 100 can receive the beacon light sent from relay satellite 200 toward satellite 100 in the unplanned communication period.

If it is assumed that all communications are planned communications as in the known technology, satellite 100 needs only to control optical communication system 103A to be directed to relay satellite 200 so as to receive the beacon light from relay satellite 200 only immediately before the planned communication time (e.g., one minute before the start of the communication), and as such does not need to control the orientation of optical communication system 103A except for the communication period for the purpose of reducing the power consumption of satellite 100. As such, for the satellite system that can perform only planned communications planned in advance, it is extremely difficult to reliably perform the unplanned communication during the period other than the planned communication time because the satellite is not prepared for receiving the beacon light from the relay satellite. Even if earth station 50 transmits a signal requesting the unplanned communication to relay satellite 200, it is difficult for relay satellite 200 to establish the optical communication with satellite 100 for the unplanned communication, and therefore, when the intended satellite 100 is not present in the communicating range of earth station 50, earth station 50 requires the time to wait for the satellite 100 coming into the communicating range.

In addition, even if relay satellite 200 has received the unplanned communication from earth station 50 and has successfully transmitted the beacon light to satellite 100, the possibility that optical communication system 103A of satellite 100 can receive the beacon light is significantly low and the possibility that the inter-satellite optical communication cannot be established is significantly high when satellite 100 does not capture relay satellite 200 at all times to transmit the beacon light.

On the other hand, in satellite system 10 according to the present disclosure, the period with a possibility of an occurrence of the unplanned communication is set in advance, and during that period optical communication unit 120 of satellite 100 is controlled such that optical communication system 103A directionally tracks relay satellite 200, and thus, when relay satellite 200 has promptly transmitted the beacon light to satellite 100 on the basis of the communication request information requesting the unplanned communication, satellite 100 can reliably receive the beacon light and can reliably establish the optical communication with relay satellite 200 with high possibility.

The following is supplementary notes regarding the above descriptions.

### Supplementary Note 1

A communication planning device including: an orbit prediction unit configured to predict an orbit of a relay satellite configured to relay a communication between an earth station and a satellite including an optical communication unit; and a creation unit configured to create control information for controlling the optical communication unit such that the optical communication unit directionally tracks the relay satellite based on the orbit predicted, in an unplanned communication period with a possibility of an occurrence of an unplanned communication between the satellite and the earth station, the unplanned communication being a communication not planned in advance. Supplementary Note 2

The communication planning device according to Supplementary Note 1, in which the creation unit specifies a first relay satellite for relaying the unplanned communication for each time period from among a plurality of the relay satellites in the unplanned communication period based on the orbit predicted, and creates the control information such that the optical communication unit is directed to the first relay satellite for each time period.

### Supplementary Note 3

The communication planning device according to Supplementary Note 1, in which when there is a request of the unplanned communication from the earth station to the satellite, the creation unit creates the communication request information including a predicted position of the satellite. Supplementary Note 4

A satellite configured to perform a communication with an earth station through a relay satellite, the satellite including: a communication unit configured to receive position identification information for specifying a position of the relay satellite for relaying an unplanned communication, in an unplanned communication period with a possibility of an occurrence of the unplanned communication between the satellite and the earth station, the unplanned communication being a communication not planned in advance; an optical communication unit configured to perform an optical communication with the relay satellite; and a directing unit configured to cause the optical communication unit to directionally track the relay satellite in the unplanned communication period based on the position identification information. Supplementary Note 5

A satellite system including: an earth station; a satellite including an optical communication unit; a relay satellite configured to relay a communication between the earth station and the satellite; and a communication planning device configured to predict an orbit of the relay satellite, and create control information of controlling the satellite such that the optical communication unit directionally tracks the relay satellite based on the orbit predicted, in an unplanned communication period with a possibility of an occurrence of an unplanned communication, the unplanned communication being a communication not planned in advance, wherein the satellite causes the optical communication unit to directionally track the relay satellite based on the control information.

### Modifications

Although the embodiments of the present disclosure have been described in detail above, the present disclosure is not limited to the specific embodiments described above, and various variations and changes are possible within the scope of the gist of the present disclosure as set out in the claims.

The above-described embodiment describes an example in which the control information includes information representing the position or direction where the relay satellite is present as viewed from satellite 100. However, in the present disclosure, satellite 100 may preliminarily retain orbit prediction data of a plurality of relay satellites 200, and satellite 100 may estimate by itself the position or direction of relay satellite 200 represented by the control information on the basis of the orbit prediction data, for example.

Likewise, the above-described embodiment describes an example in which the communication request information includes information representing the position or direction where satellite 100 is present as viewed from first relay satellite 200_1. However, in the present disclosure, relay satellite 200 may preliminarily retain orbit prediction data of a plurality of satellites, and, on the basis of the orbit prediction data of satellite 100 to be subjected to the relay, it may estimate by itself the position or direction of satellite 100 represented by the communication request information, for example.

This application is entitled to and claims the benefit of Japanese Patent Application No. 2022-025953 filed on Feb. 22, 2022, the disclosure each of which including the specification, drawings and abstract is incorporated herein by reference in its entirety.

### REFERENCE SIGNS LIST

10 Satellite system
20 Network
30 Relay satellite operator
40 Satellite operator
50 Earth station
100 Satellite
120 Optical communication unit
121 Beacon light detection unit
122 Communication establishment unit
123 Communication execution unit
130 Directional tracking unit
200 Relay satellite
210 Communication unit
220 Optical communication unit
221 Optical signal transmission/reception unit
222 Communication establishment unit
223 Communication execution unit
300 Communication planning device
310 Communication unit
320 Orbit prediction unit
330 Creation unit

1. A communication planning device comprising:
an orbit prediction unit configured to predict an orbit of a relay satellite configured to relay a communication between an earth station and a satellite including an optical communication unit; and
a creation unit configured to create control information for controlling the optical communication unit such that the optical communication unit directionally tracks the relay satellite based on the orbit predicted, in an unplanned communication period with a possibility of an occurrence of an unplanned communication between the satellite and the earth station, the unplanned communication being a communication not planned in advance.

2. The communication planning device according to claim 1, wherein the creation unit specifies a first relay satellite for relaying the unplanned communication for each time period from among a plurality of the relay satellites in the unplanned communication period based on the orbit predicted, and creates the control information such that the optical communication unit is directed to the first relay satellite for each time period.

3. The communication planning device according to claim 1, wherein when there is a request of the unplanned communication from the earth station to the satellite, the creation unit creates the communication request information including a predicted position of the satellite.

4. A satellite configured to perform a communication with an earth station through a relay satellite, the satellite comprising:
a communication unit configured to receive position identification information for specifying a position of the relay satellite for relaying an unplanned communication, in an unplanned communication period with a possibility of an occurrence of the unplanned communication between the satellite and the earth station, the unplanned communication being a communication not planned in advance;
an optical communication unit configured to perform an optical communication with the relay satellite; and
a directing unit configured to cause the optical communication unit to directionally track the relay satellite in the unplanned communication period based on the position identification information.

5. A satellite system comprising:
an earth station;
a satellite including an optical communication unit;
a relay satellite configured to relay a communication between the earth station and the satellite; and
a communication planning device configured to predict an orbit of the relay satellite, and create control information of controlling the satellite such that the optical communication unit directionally tracks the relay satellite based on the orbit predicted, in an unplanned communication period with a possibility of an occurrence of an unplanned communication, the unplanned communication being a communication not planned in advance,
wherein the satellite causes the optical communication unit to directionally track the relay satellite based on the control information.
